(19) United States
(12) Patent Application Publication
(10) Pub. No.: US 2010/0194638 A1
(43) Pub. Date: Aug. 5, 2010

(54) GNSS RECEIVER WITH WIRELESS INTERFACE

(75) Inventor: Philippe Rivard, Edinburgh (GB)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/671,022

(22) PCT Filed: Aug. 21, 2008
(86) PCT No.: PCT/EP2008/060985

§ 371 Date: Jan. 27, 2010

(30) Foreign Application Priority Data
Aug. 27, 2007 (EP) 07115011.4

(51) Int. Cl. G01S 19/05; G01S 19/36

(52) U.S. Cl. 342/357.42; 342/357.76

(57) ABSTRACT

A wireless GNSS receiver, for example a Bluetooth® receiver, including a bidirectional link to the host, and an update client, for downloading extended ephemeris data from the host, by the Bluetooth® link. The invention reuses the protocol used for NMEA data transfer, in order to send the extended ephemeris data up to the receiver. Hence, the extended ephemeris data can be sent without having to instantiate any other type of connection to the receiver. The invention reduces the cost and complexity of BT-GPS receivers that want to make use of extended ephemeris technology in order to reduce the time to first fix of GPS receivers left off for more than four hours.

### FIELD OF THE INVENTION

Embodiments of the present invention concern a method of provisioning Extended Ephemeris data or other data useful to position determination, to a GPS Receiver. In particular, but not exclusively, the present invention proposes an architecture that allows an efficient transfer of such extended ephemeris data to a GPS receiver wirelessly connected with a host system, for example by means of a Bluetooth® interface.

### RELATED ART

Ephemeris extension technology for a GPS receiver allows the receiver to obtain valid ephemeris data without it having to download this data directly from the satellites that are being tracked. This allows a GPS receiver to obtain a fix in difficult situations where the perceived signal levels would simply be too low to decode the navigation message. The extended ephemeris provides reliable information on satellite's position which is valid for a much longer time than the ephemerides included in the navigation message of GPS. The receiver can make use of the extended ephemerides in order to obtain a GPS position fix without first downloading the ephemerides from the satellites, even if it has been turned off for more than four hours.

Most GPS receivers making use of extended ephemeris technology are embedded within mobile phone platforms to download the extended ephemeris data from an external server, for example by establishing a GPRS internet connection, or to use the standard phone synchronization software to place the extended ephemeris data onto the GPS-enabled platform.

Bluetooth® GPS receivers (BT-GPS) are common products usually consisting of a standalone GPS receiver providing NMEA output, coupled to a Bluetooth® module for transmission of GPS positional data, usually in NMEA format, to any Bluetooth-enabled host platform, such as a cellular telephone, personal digital assistant or personal computer. BT-GPS receivers normally function in a unidirectional manner, that is, once the receiver is paired to its host, it simply transmits a continuous flow of navigation data, and never receives data from the host. The applications running on the host that make use of GPS data are usually limited to opening and closing the communication channel, in this case the Bluetooth® link, to the GPS receiver.

BT-GPS receivers are therefore completely self-sufficient from the host, and are able to compute and transmit a positional fix, with no or minimal assistance from the host. It is the role of the software running in the host system (for example, a navigation software or a training assistant) to process such positional data and render them appropriately on the output devices of the host system. This approach has the merit of simplifying the communication between the receiver and the host, and to provide a maximum level of interoperability between different BT-GPS receivers.

Current BT-GPS receivers do not include the same level of software integration as GPS-enabled mobile phones. That is, file transfers using the OBEX protocol are not supported by these devices, and all non-essential Bluetooth® functions are typically disabled in order to effectively secure and protect the receiver from deliberate or accidental tampering. This limits severely the assistance that the receiver can receive from the host system. Furthermore, as the manufacturing cost of these devices is critical to their acceptance in the market, they typically do not ship with enough hardware resources to easily support storage, transfer and upkeep of these files, the functions are typically absent from standard GPS receiver firmware.

It is therefore an aim of the present invention to propose a GPS receiver overcoming the limitation of the known related systems and, in particular, to propose a GPS receiver, suitable for communicating with an host system by a Bluetooth® or similar connection, that implements extended ephemeris technology, in a simple and effective way.

### BRIEF SUMMARY OF THE INVENTION

According to the invention, these aims are achieved by means of the object of the appended claims.

### BRIEF DESCRIPTION OF THE DRAWINGS

The invention will be better understood with the aid of the description of an embodiment given by way of example and illustrated by the figures, in which:

FIG. 1 shows, in a simplified schematic way, the application of extended ephemeris to a BT-GPS receiver according to one aspect of the invention.

FIG. 2 illustrates, schematically, the structure of the BT-GPS receiver of FIG. 1.

The flowcharts of FIG. 3 exemplify the process of transferring the extended ephemeris data from the host system to the BT-GPS receiver.

### DETAILED DESCRIPTION OF POSSIBLE EMBODIMENTS OF THE INVENTION

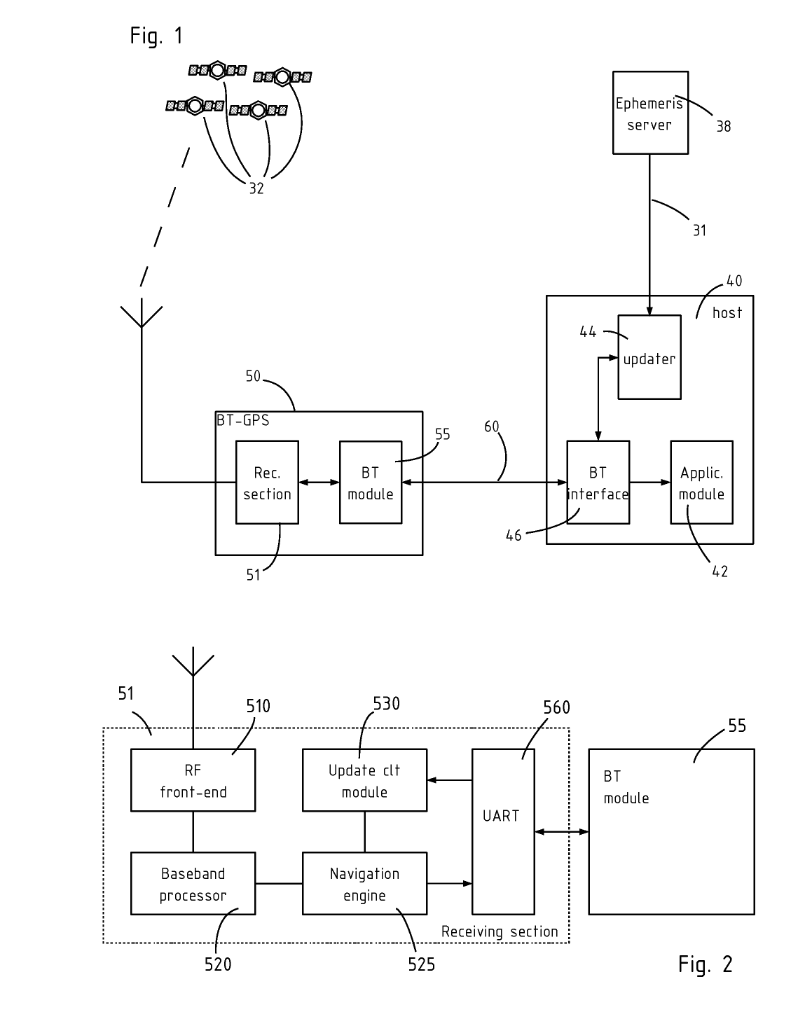

In FIG. 1 shows schematically the principle of extended ephemeris. Space Vehicles 32 emit a ranging radio signal, which allows the radiolocalization receiver 50 to compute a positional fix. The principles of Global Navigation Satellite Systems (GNSS), to which GPS, Galileo and GLONASS belong, are well known and shall not be repeated here. Even if the following description will concentrate on the GPS system, for the sake of simplicity, it must be understood that the present invention is not limited to this particular case, but can be extended to any GNSS system.

The server 38 provides the extended ephemeris data. Ephemeris data are obtained from a refined orbital model and are valid for a longer time span that the ephemeris encoded in the navigation signal receiver from the Space Vehicles 32. Extended Ephemerides allow the receiver 50 to obtain valid satellite position without relying on the navigation message downloaded from the satellites that are being tracked. This allows obtaining a fix in difficult situations where the perceived signal levels would simply be too low to decode the navigation message. The server 38 could also provide other data which could be useful to the GPS receiver 50, in addition or in alternative to the Extended Ephemerides, and it is intended that the present invention should also include this variant.

The BT-GPS 50 is equipped with a receiver section 51, which is responsible for receiving and processing the radio signals of Space Vehicles 32, and for computing positioning data, and a Bluetooth® module 55 which allows communication with an host system 40, including a compatible Bluetooth® interface 46. The Bluetooth® module 55 and interface 46 (labeled BT-module and BT interface in FIG. 1) could be replaced by Wibree, UWB, WiHD or Wireless USB interfaces or any other suitable wireless interfaces.

Host system 40 designates any system able to communicate with the BT-GPS 50 and to process the positioning data coming from the GT-GPS 50. Typically, the Host system 40 may be a fixed or portable computer, a PDA, or a cell phone, and includes an application module 42 parsing the positioning data and making use of the positioning information encoded in the data. For example the application module 42 may be a vehicle navigation software, a training assistant, or any other application relying on positioning data.

Host system 40 also includes an updater module 44 responsible for the updating of extended ephemeris, as it will be explained in the following. In a typical case, the updater module 44 would be a piece of software included in the navigation application 42. The present invention, however, also include variants in which the updater is in the firmware of the host system, or runs in a piece of hardware separate from the host system 40.

The host system has access to an extended ephemeris server 38, which provides up-to-date extended ephemeris models. Since extended ephemerides do not need to be updated very frequently, and do not represent a large amount of data, the connection 31 with the server 38 is not critical and can vary according to the nature of the host system. A mobile phone data protocol, like GPRS, EDGE or UMTS, can be used, among others.

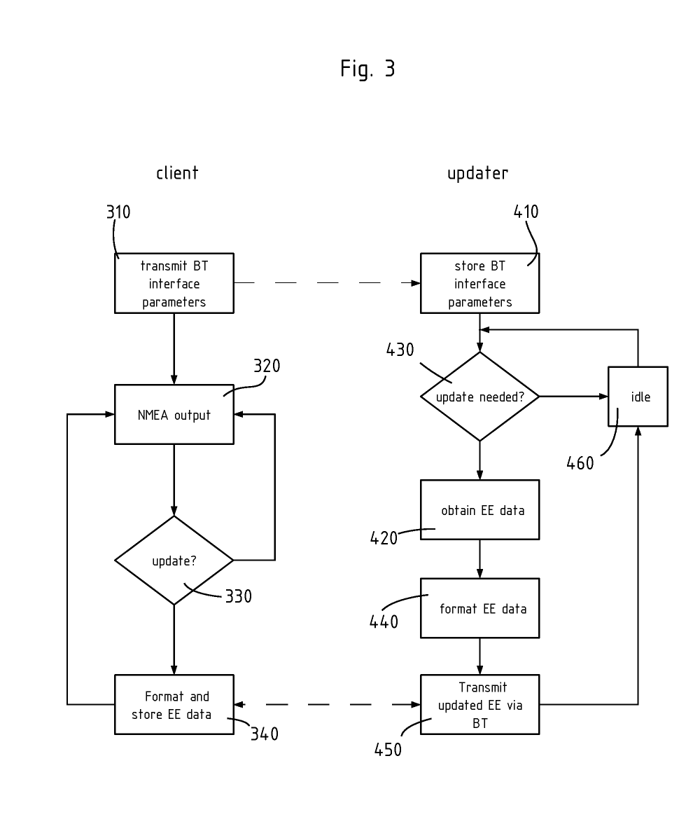

FIG. 2 shows various elements of the BT-GPS 50. A RF front-end 510 and a baseband processor 520 are used to receive the radiolocalization signals from the Space Vehicles 32, and generate correlation data, as it is known in the art. Once signal acquisition is sufficiently advanced, the navigation engine 525 can compute a positional fix, either by the ephemeris included in the GPS itself, or by using extended ephemeris data provided by the embedded update client module 530. Position data, for example formatted as NMEA strings are handled by the UART unit 560 to the Bluetooth® module 55, from where they are transmitted to the host system. According to the circumstances, the receiver 51 is realized as a single-chip unit. In some cases, however, it may be advantageous to realize the RF front-end 510, or other components, as separate units.

The UART 560 is preferably a bidirectional interface that allows also the reception of extended ephemeris data via the Bluetooth® interface, as it will be explained later. The data transfer between the wireless Bluetooth® interface and the other components of the BT-GPS receiver is bidirectional, thus allowing the update of the extended ephemeris data, or the provision of other auxiliary data, useful to the position determination, from the host system 40 to the BT-GPS 50.

According to an embodiment of the present invention, the Bluetooth® interface uses the same SPP (Serial Port Profile) communication channel on the BT-GPS receiver both for input and output, thus realizing a bidirectional serial wireless link 60. This solution allows for a configurable data transfer rate, thus permitting the GPS receiver to continue its normal operation while updating the extended ephemeris data as a low priority background task. This approach maximizes reuse of the existing hardware and software components in the existing system.

A specialized updater software module 44 runs in the host system 40. This application sends commands to the BT-GPS device 50 in order to initiate the extended ephemeris download process, to send data to the BT-GPS receiver, to terminate the extended ephemeris download process, and to check the validity of the data that has been uploaded to the receiver.

FIG. 3 illustrates schematically the steps leading to ephemeris update in the BT-GPS receiver 50 (left side) and in the updater 44 (right side). Preferably the BT-GPS receiver sends control parameters to the host during the initiation phase (step 310), in order to indicate to the updater software the maximum speed at which the data download can be undertaken, and the optimal packet size that should be used for this download. In the corresponding step 410 of FIG. 3, the updater stores the communication parameters, in memory, for future use. Preferably the BT-GPS device communicates to the updater platform-specific communication parameters in order to allow the same updater software to work over a wealth of different platforms.

Once the initiation phase has finished, the updater gathers, if needed, extended ephemeris data from the server 38 (step 420) and decides whether an update of the client is necessary (step 430). In the affirmative case the updater sends data packets (step 450) configured according to the initiation parameters to the embedded update client 530, which realizes that an update is in progress (step 330) and saves them in its non-volatile memory (step 340). The data representation of the extended ephemeris data can be modified during this step in order to be compressed, encoded, or otherwise moved to another representation for transferal purposes (step 440). The embedded update client is then responsible of reversing the transformation, thus recovering the full data set.

Checksums are added to each data packet in order to detect packet corruption early, and quickly initiate resending of the data packets dropped by the system due to data corruption. Once all data packets have been sent, the integrity of the saved data is verified through the use of a checksum scheme or an equivalent mechanism. Once the data has been verified, it can be passed onto the rest of the GPS software to be used to accelerate future GPS position fixes. The updater then enters in an idle state 460, until a new update of the extended ephemeris data is required, while the BT receiver continues its normal operation and generates a flow of position data (step 320), with the assistance of the extended ephemeris data, stored in step 340.

In the previous example the update of the extended ephemerides and the generation of position data are illustrated as exclusive operations, for the sake of simplicity. It is important to keep in mind, however, that in a real implementation the two operations may happen concurrently, the BT-GPS generating position fixes without interruption, while the extended ephemeris data are updated.

The invention reuses the standard protocol used for NMEA data transfer, in order to send the extended ephemeris data up to the receiver. Hence, the extended ephemeris data can be sent without having to instantiate any other type of connection to the receiver, and can even be done while the system is running, by the NMEA parsing application.

Existing BT-GPS products can be modified in order to add extended ephemeris support by reprogramming of the GPS receiver software, and in some circumstances, enabling of the incoming Bluetooth® data channel by making limited hardware modification.

The main advantage of the invention is that it reduces the cost and complexity of BT-GPS receivers that want to make use of extended ephemeris technology in order to reduce the time to first fix of GPS receivers left off for more than four hours.

Furthermore, the ease-of-use of this solution allows the provisioning of extended ephemeris data to become much more transparent to the user, as mapping applications and other software running on the host platform can silently update extended ephemeris data on any receiver using this technology in the background, during normal receiver operation.

1. A GNSS receiver (50), including a RF front-end (510), a signal processor (520) and a navigation engine (525) arranged to compute position data representing the receiver's location, based on radio signals received from radiolocalization satellites, the GNSS receiver further including a wireless interface (55) for communicating the position data to a host system (40), characterized in that the communication between the wireless interface (55) and other components of the receiver (50) is bidirectional.

2. The GNSS receiver of the previous claim, further comprising a client module (530), operatively arranged to receive auxiliary data from the wireless interface (55), the auxiliary data being used to aid the computation of position data.

3. The GNSS receiver of the previous claim, wherein the auxiliary data includes extended ephemeris data.

4. The GNSS receiver of any of the previous claims, wherein the wireless interface (55) is a Bluetooth® interface or a Wibree interface.

5. The GNSS receiver of any of the previous claims, further comprising a bidirectional UART (560) for the communication between the wireless interface (55) and other components of the receiver (50).

6. The GNSS receiver of any of the previous claims, wherein the wireless interface is arranged to use a bidirectional SPP communication channel between the GNSS receiver and the host (40).

7. The GNSS receiver of any of the claims from 2 to 6, in combination with a host device (40) comprising a host wireless interface (46) interoperable with the wireless interface of the GNSS receiver (55) to create a bidirectional wireless serial link (60) between receiver and host, and an updater module (44) of the host device (40), configured to transmit the auxiliary data to the client module (530) of the GNSS receiver (50).
